(19) United States
(12) Patent Application Publication
(10) Pub. No.: US 2018/0123767 A1
(43) Pub. Date: May 3, 2018

(54) System and Method for Reliable Transmission in Communications Systems

(71) Applicant: Huawei Technologies Co., Ltd., Shenzhen (CN)

(72) Inventors: Toufiqul Islam, Ottawa (CA); Peng Zhang, Shanghai (CN); Yongxia Lyu, Shenzhen (CN)

(21) Appl. No.: 15/792,411

(22) Filed: Oct. 24, 2017

Related U.S. Application Data
(60) Provisional application No. 62/416,523, filed on Nov. 2, 2016.

(51) Int. Cl. H04L 5/00; H04L 1/18

(52) U.S. Cl. CPC H04L 5/0057; H04L 1/189; H04L 67/12; H04L 5/0055; H04L 1/1816

(57) ABSTRACT

A method for communications includes transmitting, by a transmission point (TP) to a reception point (RP), a data packet, receiving, by the TP from the RP, a first feedback indicating that the data packet was unsuccessfully decoded, wherein the first feedback comprises a confidence indicator indicating a confidence level of the RP in decoding the data packet, and transmitting, by the TP to the RP, a plurality of retransmissions of the data packet.

This application claims the benefit of U.S. Provisional Application No. 62/416,523, filed on Nov. 2, 2016, entitled “System and Method for Reliable Transmission in Communications Systems,” which application is hereby incorporated herein by reference.

### TECHNICAL FIELD

The present disclosure relates generally to a system and method for digital communications, and, in particular embodiments, to a system and method for reliable transmission in communications systems.

### BACKGROUND

Ultra-reliable, low latency communications (URLLC) is a usage scenario being studied in Fifth Generation (5G) communications systems. Generally, URLLC has strict performance requirements, especially in terms of latency and reliability. A typical performance requirement being considered for URLLC is for latency on the order of less than or equal to 1 millisecond (ms) and reliability at 99.999% or higher. Intended applications for URLLC include augmented reality, wireless automation, vehicular (e.g., automobiles, air planes, drones, mobile service robots, and so on) efficiency and safety, mobile gaming, and so forth.

### SUMMARY

Example embodiments provide a system and method for reliable transmission in communications systems.

In accordance with an example embodiment, a method for communications is provided. The method includes transmitting, by a transmission point (TP) to a reception point (RP), a data packet, receiving, by the TP from the RP, a first feedback indicating that the data packet was unsuccessfully decoded, wherein the first feedback comprises a confidence indicator indicating a confidence level of the RP in decoding the data packet, and transmitting, by the TP to the RP, a plurality of retransmissions of the data packet.

Optionally, in any of the preceding embodiments, wherein a number of retransmissions in the plurality of retransmissions of the data packet is determined in accordance with the first feedback.

Optionally, in any of the preceding embodiments, wherein a number of retransmissions in the plurality of retransmissions of the data packet is also determined in accordance with historical information.

Optionally, in any of the preceding embodiments, wherein historical information comprises at least one of historical transmission/reception failures or successes of the TP, or historical transmission/reception failures or successes of other devices.

Optionally, in any of the preceding embodiments, wherein the confidence indicator is determined based on at least one of a channel quality feedback information or a decoder status information.

Optionally, in any of the preceding embodiments, wherein the channel quality feedback information comprises information associated with at least one of a signal to noise ratio (SNR), a signal plus interference to noise ratio (SINR), a reference signal received power (RSRP), or a reference signal received quality (RSRQ), of a link between the TP and the RP, and wherein the decoder status information comprises information associated with a log likelihood ratio (LLR).

Optionally, in any of the preceding embodiments, wherein the method further comprises transmitting, by the TP before receiving the first feedback, at least one blind retransmission of the data packet.

Optionally, in any of the preceding embodiments, wherein the data packet and the at least one blind retransmission of the data packet contain the same data.

In accordance with an example embodiment, a method for communications is provided. The method includes receiving, by a RP from a TP, a data packet, transmitting, by the RP to the TP, a feedback indicating that the data packet was unsuccessfully decoded, wherein the feedback comprises a confidence indicator indicating a confidence level of the RP in decoding the data packet, and receiving, by the RP from the TP, a plurality of retransmissions of the data packet.

Optionally, in any of the preceding embodiments, wherein a number of retransmissions in the plurality of retransmissions of the data packet is determined in accordance with the feedback.

Optionally, in any of the preceding embodiments, wherein the method further comprises receiving, by the RP, at least one blind retransmission of the data packet prior to transmitting the feedback.

Optionally, in any of the preceding embodiments, wherein the data packet and the at least one blind retransmission of the data packet contain same data.

Optionally, in any of the preceding embodiments, wherein the confidence indicator is determined based on at least one of a channel quality feedback information comprising information associated with at least one of a SNR, a SINR, a RSRP, or a RSRQ, of a link between the TP and the RP, or a decoder status information comprising information associated with a LLR.

In accordance with an example embodiment, a TP adapted to perform communications is provided. The TP includes a processor, and a computer readable storage medium storing programming for execution by the processor. The programming including instructions to configure the TP to transmit a data packet to a RP, receive a first feedback from the RP, the first feedback indicating that the data packet was unsuccessfully decoded, wherein the first feedback comprises a confidence indicator indicating a confidence level of the RP in decoding the data packet, and transmit a plurality of retransmissions of the data packet to the RP.

Optionally, in any of the preceding embodiments, wherein a number of retransmissions in the plurality of retransmissions of the data packet is determined in accordance with the first feedback.

Optionally, in any of the preceding embodiments, wherein the programming includes instructions to configure the TP to determine a number of retransmissions in the plurality of retransmissions of the data packet in accordance with historical information.

Optionally, in any of the preceding embodiments, wherein the confidence indicator is determined based on at least one of a channel quality feedback information or decoder status information.

Optionally, in any of the preceding embodiments, wherein the channel quality feedback information comprises information associated with at least one of a SNR, a SINR, a RSRP, or a RSRQ, of a link between the TP and the RP, and wherein the decoder status information comprises information associated with a LLR.

In accordance with an example embodiment, a RP adapted to perform communications is provided. The RP includes a processor, and a computer readable storage medium storing programming for execution by the processor. The programming including instructions to configure the RP to receive a data packet from a TP, transmit a feedback to the TP, the feedback indicating that the data packet was unsuccessfully decoded, wherein the feedback comprises a confidence indicator indicating a confidence level of the RP in decoding the data packet, and receive a plurality of retransmissions of the data packet from the TP.

Optionally, in any of the preceding embodiments, wherein the programming includes instructions to configure the RP to receive at least one blind retransmission of the data packet prior to transmitting the feedback.

Optionally, in any of the preceding embodiments, wherein a number of retransmissions in the plurality of retransmissions of the data packet is determined in accordance with the feedback.

Optionally, in any of the preceding embodiments, wherein the confidence indicator is determined based on at least one of a channel quality feedback information comprising information associated with at least one of a SNR, a SINR, a RSRP, or a RSRQ, of a link between the TP and the RP, or a decoder status information comprising information associated with a LLR.

In accordance with an example embodiment, a method for communications is provided. The method includes transmitting, by a TP, a data packet to a RP, and transmitting, by the TP, a number of repeat packets in accordance with a first decoding indicator indicating that the data packet was unsuccessfully decoded, wherein the number is at least two.

Optionally, in any of the preceding embodiments, wherein the method further comprises transmitting, by the TP, at least one blind repeat packet prior to receiving the first decoding indicator.

Optionally, in any of the preceding embodiments, wherein the at least one blind repeat packet is transmitted automatically after transmitting the data packet.

Optionally, in any of the preceding embodiments, wherein the data packet and the blind repeat packet contain same data.

Optionally, in any of the preceding embodiments, wherein the first decoding indicator comprises a confidence indicator indicating a confidence level of the RP in decoding the data packet, and wherein a number of repeat packets transmitted is in accordance with the confidence level.

Optionally, in any of the preceding embodiments, wherein the number of repeat packets transmitted is in accordance with a confidence value derived from feedback received by the TP.

Optionally, in any of the preceding embodiments, wherein the feedback comprises at least one of a SNR, a SINR, a LLR value, RSRP, or RSRQ, of a link between the TP and the RP.

Optionally, in any of the preceding embodiments, wherein the first decoding indicator comprises a negative acknowledgement (NACK).

Optionally, in any of the preceding embodiments, wherein the data packet and the repeat packets contain same data.

Optionally, in any of the preceding embodiments, wherein the data packet and the number of the repeat packets are transmitted in a time division duplexed (TDD) communications system.

Optionally, in any of the preceding embodiments, wherein the method further comprises receiving, by the TP, a second decoding indicator indicating that the data packet was successfully decoded, and stopping, by the TP, a remaining incomplete transmission of the repeat packets.

In accordance with an example embodiment, a method for communications is provided. The method includes receiving, by a RP, a data packet from a TP, transmitting, by the RP, a first decoding indicator indicating that the data packet was unsuccessfully decoded, and receiving, by the RP, at least two repeat packets from the RP.

Optionally, in any of the preceding embodiments, wherein the method further comprises receiving, by the RP, at least one blind repeat packet prior to transmitting the first decoding indicator.

Optionally, in any of the preceding embodiments, wherein the data packet and the blind repeat packet contain same data.

Optionally, in any of the preceding embodiments, wherein the first decoding indicator comprises a confidence indicator indicating a confidence level of the RP in decoding the data packet.

Optionally, in any of the preceding embodiments, wherein the method further comprises transmitting, by the RP, feedback regarding a link between the RP and the TP.

Optionally, in any of the preceding embodiments, wherein the feedback comprises at least one of a SNR, a SINR, LLR values, RSRP, or RSRQ, of the link.

Optionally, in any of the preceding embodiments, wherein the data packet and the repeat packets contain same data.

Optionally, in any of the preceding embodiments, wherein the method further comprises attempting, by the RP, to decode the data packet in conjunction with at least one of the repeat packets, and transmitting, by the RP, a second decoding indicator indicating that the data packet was unsuccessfully decoded.

In accordance with an example embodiment, a TP adapted to perform communications is provided. The TP includes a processor, and a computer readable storage medium storing programming for execution by the processor. The programming including instructions to configure the TP to transmit a data packet to a RP, and transmit a number of repeat packets in accordance with a first decoding indicator indicating that the data packet was unsuccessfully decoded, wherein the number is at least two.

Optionally, in any of the preceding embodiments, wherein the programming includes instructions to configure the TP to transmit at least one blind repeat packet prior to receiving the first decoding indicator.

Optionally, in any of the preceding embodiments, wherein the at least one blind repeat packet is transmitted automatically after transmitting the data packet.

Optionally, in any of the preceding embodiments, wherein the first decoding indicator comprises a confidence indicator indicating a confidence level of the RP in decoding the data packet, and wherein a number of repeat packets transmitted is in accordance with the confidence level.

Optionally, in any of the preceding embodiments, wherein the number of repeat packets transmitted is in accordance with a confidence value derived from feedback received by the TP.

Optionally, in any of the preceding embodiments, wherein the programming includes instructions to configure the TP to receive a second decoding indicator indicating that the data packet was successfully decoded, and stop a remaining incomplete transmission of the repeat packets.

In accordance with an example embodiment, a RP adapted to perform communications is provided. The RP includes a processor, and a computer readable storage medium storing programming for execution by the processor. The programming including instructions to configure the RP to receive a data packet from a TP, transmit a first decoding indicator indicating that the data packet was unsuccessfully decoded, and receive at least two repeat packets from the RP.

Optionally, in any of the preceding embodiments, wherein the programming includes instructions to configure the RP to receive at least one blind repeat packet prior to transmitting the first decoding indicator.

Optionally, in any of the preceding embodiments, wherein the programming includes instructions to configure the RP to transmit feedback regarding a link between the RP and the TP.

Practice of the foregoing embodiments enables an increase in the number of packet retransmissions opportunities for URLLC, thereby increasing the reliability of the transmission. Furthermore, the restricting of the retransmissions to occur within a single frame, ensuring that the latency requirements are met.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates an example communications system according to example embodiments described herein;

FIGS. 2A-2C illustrate example URLLC TDD frame structures according to example embodiments described herein;

FIG. 3 illustrates an example DL-dominated URLLC TDD frame structure, highlighting packet retransmissions;

FIG. 4A illustrates a flow diagram of example operations occurring in a transmission point communicating with a reception point using URLLC according to example embodiments described herein;

FIG. 4B illustrates a flow diagram of example operations occurring in a reception point communicating with a transmission point using URLLC according to example embodiments described herein;

FIG. 5 illustrates an example DL-dominated URLLC TDD frame structure, highlighting bundled retransmissions triggered by a NACK according to example embodiments described herein;

FIG. 6A illustrates a flow diagram of example operations occurring in a transmission point communicating with a reception point using URLLC with acknowledgement-less retransmissions according to example embodiments described herein;

FIG. 6B illustrates a flow diagram of example operations occurring in a reception point communicating with a transmission point using URLLC with acknowledgement-less retransmissions according to example embodiments described herein;

FIG. 6C illustrates a flow diagram of example operations occurring in a reception point using acknowledgement-less retransmissions and confidence value to reduce a number of A/Ns transmitted according to example embodiments described herein;

FIG. 7 illustrates an example DL-dominated URLLC TDD frame structure, highlighting automatic acknowledgement-less retransmission and bundled retransmissions triggered by a NACK according to example embodiments described herein;

FIG. 8 illustrates an example UL-dominated URLLC TDD frame structure, highlighting automatic acknowledgement-less retransmission and bundled retransmissions triggered by a NACK according to example embodiments described herein;

FIG. 9 illustrates an example bidirectional URLLC TDD frame structure, highlighting automatic acknowledgement-less retransmission and bundled retransmissions triggered by a NACK according to example embodiments described herein;

FIG. 10 illustrates a flow diagram of example operations occurring in an AN transmitting a packet with support for reliable transmission according to example embodiments described herein;

FIG. 11 illustrates a flow diagram of example operations occurring in an AN determining a number of retransmissions in accordance with a confidence indicator and/or feedback according to example embodiments described herein;

FIG. 12 illustrates a flow diagram of example operations occurring in a UE providing feedback according to example embodiments described herein;

FIG. 13 illustrates a block diagram of an embodiment processing system for performing methods described herein; and

FIG. 14 illustrates a block diagram of a transceiver adapted to transmit and receive signaling over a telecommunications network according to example embodiments described herein.

### DETAILED DESCRIPTION OF ILLUSTRATIVE EMBODIMENTS

The making and using of the disclosed embodiments are discussed in detail below. It should be appreciated, however, that the present disclosure provides many applicable inventive concepts that can be embodied in a wide variety of specific contexts. The specific embodiments discussed are merely illustrative of specific ways to make and use the embodiments, and do not limit the scope of the disclosure.

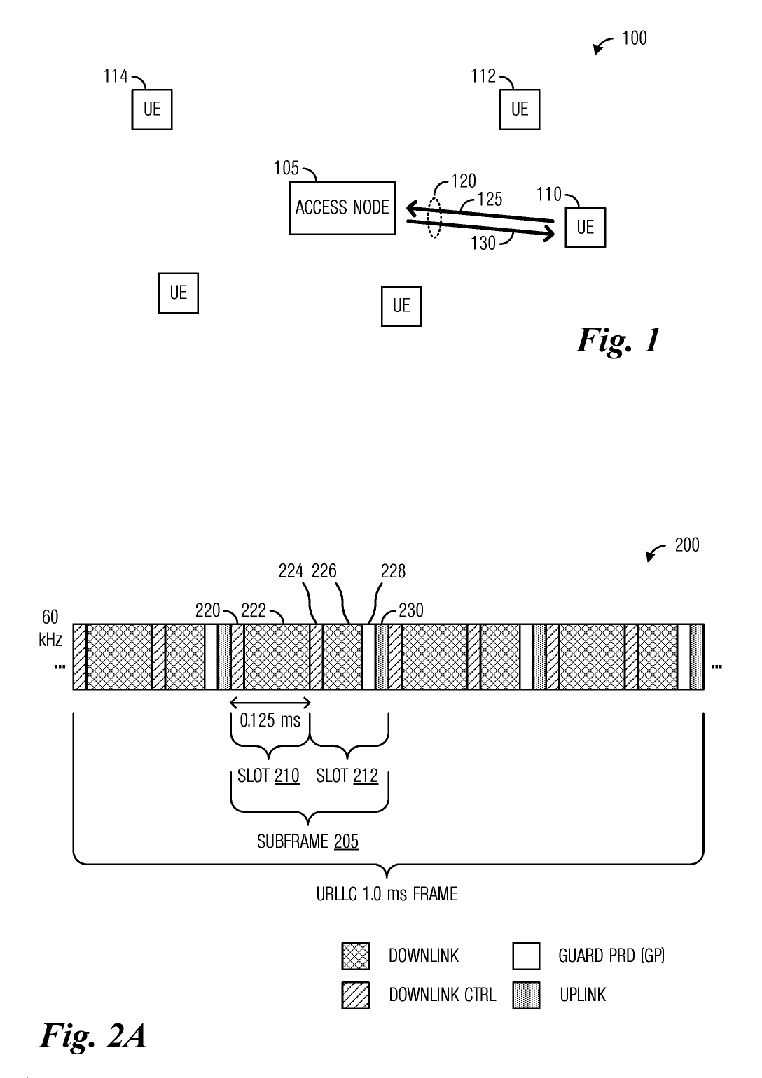

FIG. 1 illustrates an example communications system 100. Communications system 100 includes an access node (AN) 105 that serves a plurality of user equipments (UEs), such as UE 110, UE 112, and UE 114. ANs are also commonly referred to as access points, base stations, base terminal stations, controllers, NodeBs, evolved NodeBs (eNBs), master eNBs (MeNBs), secondary eNBs (SeNBs), and so on. Similarly, UEs are also commonly referred to as mobiles, mobile stations, stations, subscribers, terminals, users, and so forth.

Communications between AN 105 and a UE, such as UE 110, occur over a link 120. In some implementations, link 120 comprises an uplink (UL) 125 that conveys transmissions from the UE to AN 105 and a downlink (DL) 130 that conveys transmissions from AN 105 to the UE. UL 125 and DL 130 may be separated in time (time division duplexed (TDD)), frequency (frequency division duplexed (FDD)), code (code division duplexed (CDD)), space (space division duplexed (SDD)), or a combination thereof.

While it is understood that communications systems may employ multiple ANs capable of communicating with a number of UEs, only one AN, and 5 UEs are illustrated for simplicity.

As discussed previously, many applications of URLLC will require an end-to-end latency of a few milliseconds (ms) or less, reliable packet delivery of 99.999% or higher, block error rates on the order of 10⁻⁹, and so forth.

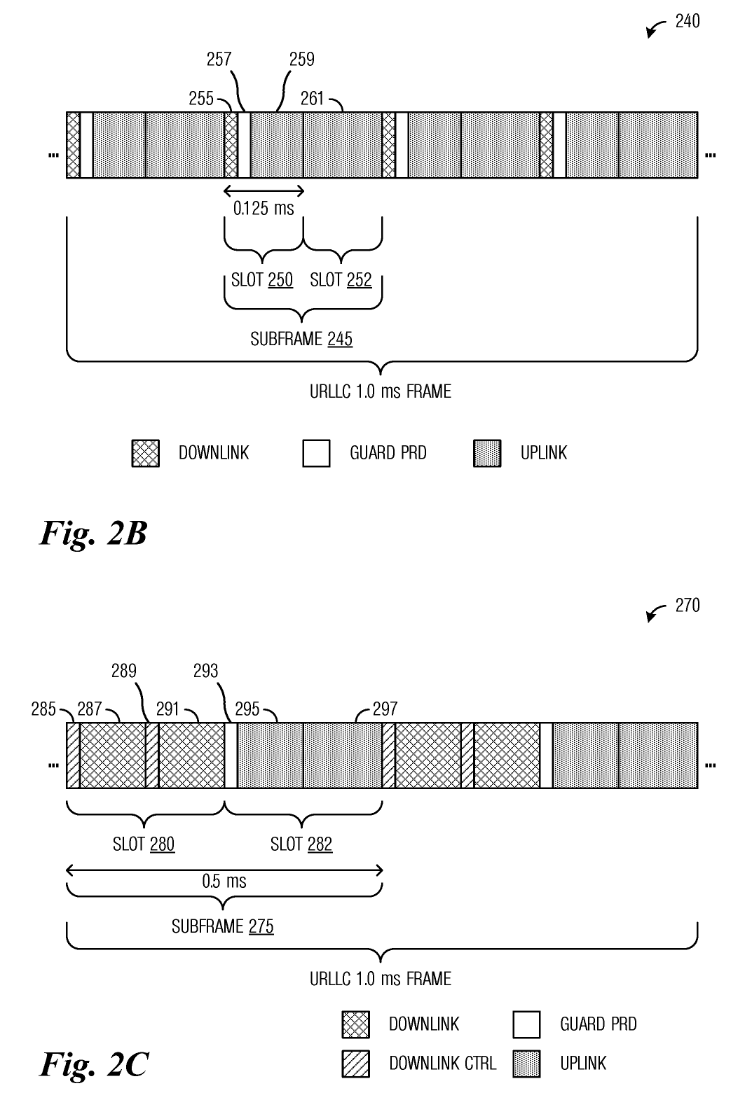

FIGS. 2A-2C illustrate example URLLC TDD frame structures. FIG. 2A illustrates example DL-dominated URLLC TDD frame structure 200. DL-dominated URLLC TDD frame structure 200 is 1 ms in duration in order to meet a 1 ms latency bound, for example. It is understood that DL-dominated URLLC TDD subframes may be used in a communications system where end-to-end latency of a packet can be 1 ms or less, for example. However, DL-dominated URLLC TDD subframes may be used in communications systems with other latency requirements. In a situation with a different latency bound, a different frame structure duration is possible. DL-dominated URLLC TDD frame structure 200 comprises a plurality of subframes, such as subframe 205. The subframes of DL-dominated URLLC TDD frame structure 200 include two slots, such as slots 210 and 212 for subframe 205, which in the example shown in FIG. 2A are 0.125 ms each in duration.

The slots of a subframe may be configured differently. As shown in FIG. 2A, slot 210 comprises a downlink control portion 220 and a downlink portion 222, while slot 212 comprises a downlink control portion 224, a downlink portion 226, a guard period (GP) 228, and an uplink portion 230. It is noted that the configuration of DL-dominated URLLC TDD frame structure 200 shown in FIG. 2A is for illustrative purposes only and that other configurations are possible. An example of another DL-dominated URLLC TDD frame structure includes a frame structure where there are a number (e.g., 2, 3, 4, or more) of downlink only slots that are followed by a bidirectional slot or an uplink only slot.

FIG. 2B illustrates an example UL-dominated URLLC TDD frame structure 240. As shown in FIG. 2B, UL-dominated URLLC TDD frame structure 240 is 1 ms in duration in order to meet a 1 ms latency bound. In a situation with a different latency bound, a different frame structure duration is possible. UL-dominated URLLC TDD frame structure 240 comprises a plurality of subframes, such as subframe 245. The subframes of UL-dominated URLLC TDD frame structure 240 include two slots, such as slots 250 and 252, which in FIG. 2B are 0.125 ms each in duration. The slots of a subframe may be configured differently. As shown in FIG. 2B, slot 250 comprises a downlink portion 255, a GP 257, and an uplink portion 259, while slot 252 includes an uplink portion 261. It is noted that the configuration of UL-dominated URLLC TDD frame structure 240 shown in FIG. 2B is for illustrative purposes only and that other configurations are possible. An example of another UL-dominated URLLC TDD frame structure includes a frame structure where there are a number (e.g., 2, 3, 4, or more) of uplink only slots that are followed by a bidirectional slot or a downlink only slot.

It is noted that downlink portions of UL dominated subframes usually are used to convey control information. However, if in some instances, downlink data may be conveyed.

FIG. 2C illustrates an example bidirectional URLLC TDD frame structure 270. As shown in FIG. 2C, bidirectional URLLC TDD frame structure 270 is 1 ms in duration in order to meet a 1 ms latency bound. Bidirectional URLLC TDD frame structure 270 comprises a plurality of subframes, such as subframe 275. The subframes of bidirectional URLLC TDD frame structure 270 are 0.5 ms each in duration. It is noted that other subframe durations are possible. Furthermore, a ratio of downlink to uplink does not need to be 1:1. The subframes of bidirectional URLLC TDD frame structure 270 include two slots, such as slots 280 and 282. As shown in FIG. 2C, slot 280 comprises a first downlink control portion 285, a first downlink portion 287, a second downlink control portion 289, and a second downlink portion 291, while slot 282 includes a GP 293, a first uplink portion 295, and a second uplink portion 297. It is noted that the configuration of bidirectional URLLC TDD frame structure 270 shown in FIG. 2C is for illustrative purposes only and that other configurations are possible.

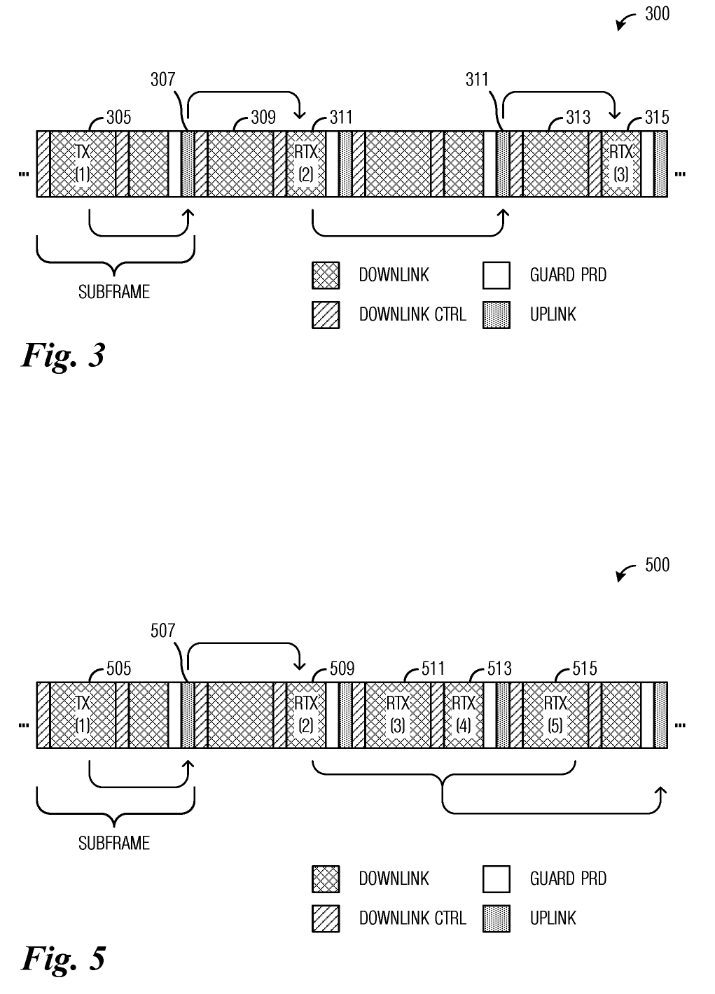

FIG. 3 illustrates an example DL-dominated URLLC TDD frame structure 300, highlighting packet retransmissions. As shown in FIG. 3, packet retransmissions are triggered by the reception of a negative acknowledgement (NACK). On the other hand, if an acknowledgment (ACK) is received, the packet transmission is considered to have been completed successfully. For discussion purposes, the following assumptions are made:
A retransmission takes place one slot after an ACK/NACK (A/N) is received. In other words, an immediately scheduled retransmission in a slot immediately following the A/N may not be feasible; and
An A/N of a transmission (e.g., downlink) occurring in a self-contained interval may not be fed back in a symbol (e.g., uplink) of that same slot. In other words, an A/N for a transmission occurring in a subframe may not be fed back in the same slot.

It is noted that the discussion of FIG. 3 are for illustrative purposes only and that some devices may be capable of providing hybrid automatic repeat request (HARQ) feedback right away in a subsequent UL portion of the same slot. Hence, the location of the feedback may not be a limiting factor on what is included in the feedback.

It is noted that the ability to immediately schedule a retransmission in a slot immediately following an A/N may depend on the processing time involved in decoding the A/N, as well as the frame structure being used. Therefore, the discussion regarding the inability to immediately schedule a retransmission should not be construed as being limiting to either the scope or the spirit of the example embodiments. As an illustrative example, consider a situation where a subframe of bidirectional URLLC frame structure includes 2 or more uplink symbols and an A/N is transmitted in an uplink symbol that is not the last uplink symbol, then it is possible for the transmitting device to receive the A/N and react to the A/N in the next downlink slot. As another illustrative example, consider a situation wherein a downlink slot has 2 or more downlink symbols for downlink control and response to the A/N may be conveyed in the second downlink symbol of the downlink control, then it is possible for the reaction to the A/N to occur in next appropriate slot.

An initial downlink packet is transmitted by an AN in a downlink portion 305 of DL-dominated URLLC TDD frame structure 300. The UE receives the initial downlink packet but is unable to decode the initial downlink packet and transmits a NACK in an uplink portion 307, which is the first uplink transmission opportunity of DL-dominated URLLC TDD frame structure 300. Because the NACK is received in uplink portion 307, the AN may not be able to retransmit the packet in downlink portion 309. Instead, the packet is retransmitted in downlink portion 311. For discussion purposes, consider a situation wherein the UE is unable to successfully decode the retransmitted packet received in downlink portion 311, hence the UE transmits a NACK in an uplink portion 313, which is the first uplink transmission opportunity of DL-dominated URLLC TDD frame structure 300 after downlink portion 311. Once again, the AN may not able to retransmit the packet in downlink portion 313 and retransmits the packet in downlink portion 315.

As discussed previously, when and where a device or AN is able to retransmit (or transmit an A/N may depend upon the capabilities of the device or AN, feedback processing time as well as the availability of resources. The discussion presented in FIG. 3 are for illustrative purposes only and is not intended to be limiting to the scope or the spirit of the example embodiments. For example, if the AN is capable and if resources are available, the AN may be able to retransmit the packet in downlink portion 313.

It is noted that the retransmission of the packet in downlink portion 315 may not be useful in the generation of a corresponding A/N because the UE may not be able to transmit the A/N before expiration of the 1 ms bound (i.e., the end of DL-dominated URLLC TDD frame structure 300), therefore any subsequent retransmissions of the packet arising from the A/N would occur outside of the 1 ms bound. Although DL-dominated URLLC TDD frame structure 300 has a large number of downlink transmission opportunities (i.e., 7), the maximum number of transmissions and retransmission of the packet is 3. Therefore, there is a need to increase the efficiency of the transmission and retransmission process to increase the number of usable transmission opportunities, and thereby, increase the reliable packet delivery rate.

According to an example embodiment, reliable packet delivery requirements are met through the retransmission of packets. The retransmitted packets may be decoded separately. Alternatively, the retransmitted packets may be combined with the original packet and the combined packet is jointly decoded, exploiting joint decoding and/or diversity techniques to improve decoding performance. However, in order to meet latency requirements, the retransmitted packets should occur within the maximum permissible latency value of the transmission of the original packet.

According to an example embodiment, a NACK triggers a plurality of retransmissions. Instead of triggering a single retransmission of a packet, a NACK triggers a plurality of retransmissions of the packet. The number of retransmissions of the packet may be pre-configured, may be specified in a technical standard, may be specified by an operator of the communications system, may be based on a number of available transmission opportunities, may be based on a confidence value reported by the device transmitting the NACK, may be based on a confidence value determined by the device receiving the NACK, and so forth, or a combination thereof. Examples of the confidence value include a signal to noise ratio (SNR), a signal plus interference to noise ratio (SINR), log likelihood ratio (LLR) values, and so forth, or any other decoder status information.

In an example, decoder status information may be based on LLR values. LLR values for the bits in a codeword are also called soft information. The LLR values may be obtained for encoded bits after de-mapping at the receiver (e.g., soft input to the decoder) or for information bits at the output of the decoder (e.g., soft output of the decoder). A metric based on LLR values may be obtained to represent decoder status information. In an illustrative example, if a codeword/packet has N bits, then for each bit, a LLR value may be determined. If x out of N LLR values (where x is less than or equal to N) for the N bits or x percent of the N LLR values exceed a pre-defined threshold on LLR value (e.g., an absolute value of a LLR value of a bit exceed a threshold), then a metric determined from the decoder status information may be referred to as confident. If x out of N LLR values or x percent of the N LLR values does not exceed the pre-defined threshold, then the metric determined from the decoder status information may be referred to as not confident. As an example, if 80 (or some other numerical value) percent or more of the LLR values of a codeword/packet exceed a threshold, the metric is confident, otherwise the metric is not confident.

It should be understood that multiple thresholds can be used if more than two possible metric values (i.e., confident/not confident) are supported. In an example, a UE may be configured to include decoder status information to the HARQ feedback only if a NACK is feedback, i.e., the UE may not need to include decoder status information if it is feeding back an ACK. Alternatively, HARQ feedback of a configured (either semi-statically configured by radio resource control (RRC) or dynamically configured by downlink control information (DCI)) UE always includes decoder status information with HARQ feedback. In one example, feedback comprises two bits, first bit is used for HARQ feedback (ACK/NACK), and second bit is used for decoder status information (confident/not confident). In another example, both bits are representative of decoder status information, e.g., four levels of decoder status information can be feedback, where a first level can be referred to as ACK, and other three levels can be regarded as NACK with different degree of confidence. In the context of above example, an example of multiple thresholds may be as follows: a) if x>90% and/or decoding is successful, the decoder status information can be ACK, b) if 80<=x<90% and/or decoding is unsuccessful, the decoder status information can be NACK and confidence is high (here ‘high confidence’ refers to a state where the decoder was very close to successfully decoding the packet), c) if 70<=x<80% and/or decoding is unsuccessful, the decoder status information can be NACK and confidence is moderate, d) x<70% and/or decoding is unsuccessful, the decoder status information can be NACK and confidence is low. It is noted that the example of the multiple thresholds are for discussion purposes only and that other examples of multiple thresholds are possible. An exact mapping of confidence based on LLR values can be UE specific configured.

As discussed herein, retransmissions can be also be referred to as repetitions, i.e., a transmission block (TB) is repeated/retransmitted multiple times and either by a DL control information channel or RRC, a UE may be notified of how many repetitions/retransmissions are scheduled/configured following a NACK. The repetitions of a TB can be of same or different redundancy versions.

The discussion of URLLC is intended to present an example scenario for the example embodiments. The example embodiments presented herein may be applied to other forms of communications systems, including enhanced mobile broadband (eMBB) communications systems, and so forth. Motivation for the example embodiments do not only include increasing the number of retransmission opportunities within a latency budget, but also to lower the number of A/N transmissions, which helps to reduce overhead and avoid error over multiple HARQ feedback channels during transmissions.

The example embodiments presented herein may also be applied to other forms of communications systems, including machine type communications, and so forth.

In an embodiment, whether a UE includes a confidence indicator or a measurement report/outcome of the processing of some information in the HARQ feedback or NACK feedback depends on a configuration indication received by the UE. In one example, the UE may be configured by higher layer signaling, e.g., radio resource control (RRC) signaling or medium access control (MAC) control element (CE), to transmit NACK or HARQ feedback including additional bits that correspond to a confidence indicator. In one example, a UE-specific table can be constructed where example representations of different bit combinations in the augmented HARQ feedback is listed and a certain HARQ feedback indicates the index of an entry in the table. For example, for a given configuration of HARQ feedback comprising two bits, bit values “11” may indicate ACK, bit values “10” may indicate very confident, bit values “01” may indicate moderately confident, while bit values “00” may indicate not confident. Other examples are possible. The entries in the UE-specific table can be taken from a larger table specified in the standards specification. The UE-specific table can be RRC configured to a UE. In another example, UE may receive an indication in the DCI channel that the UE includes such information (e.g., a confidence indicator or a measurement report/outcome) in the feedback. The DCI can be group-common control DCI or UE specific DCI such as a scheduling grant received in a physical downlink control channel (PDCCH). The PDCCH may include a field with one bit, where a bit value ‘1’ may indicate that the UE transmits enhanced HARQ feedback (including a confidence indicator or a measurement report/outcome, for example) and a bit value ‘0’ may indicate that the UE transmits regular HARQ feedback, i.e., without appending the additional information to the A/N, or vice versa. In an example, a physical uplink control channel (PUCCH) format can be used to include such information. PUCCH format 1 in LTE is used for transmitting HARQ feedback and scheduling request carrying up to two bits of information. In another example, a payload of a PUCCH format, e.g., PUCCH format 1, may be augmented to facilitate multi-bit HARQ feedback such as for including a confidence indicator. A device can be configured with one or more PUCCH formats that support feedback of a confidence indicator. As discussed above, configuration information may be provided by higher layer signaling, such as RRC or MAC CE, for example. In yet another example, the DCI may indicate in a field whether a configured PUCCH format is used with a default configuration (e.g., without confidence indicator) or an enhanced configuration (e.g., with confidence indicator) with additional bits. The PUCCH format may have M (where M is greater than or equal to one) bits for the default configuration and N bits (where N is greater than M) for the enhanced configuration, e.g., HARQ feedback appended with additional bits to indicate confidence status, for example. In a further example of a UE/device behavior, the UE only uses enhanced configuration of the PUCCH format if indicated by the DCI, otherwise the UE uses the default configuration.

In an embodiment, the confidence indicator reporting may be activated for one or more of: initial DL transmission, or subsequent DL transmission(s)/(re)-transmission(s). The UE can be configured by RRC to be notified of which DL transmission(s) of a TB (i.e., initial or (re)-transmission(s) or both) would result in an extended HARQ feedback with confidence values. In another example, the activation of such extended HARQ feedback transmission may be provided by the scheduling grant/PDCCH of the respective DL transmission only. In another example, the number of bits used in the HARQ feedback including confidence indicator can be configured to be same or different for initial and (re)-transmissions. It is noted that (re)-transmission refers to any transmission of a TB that is scheduled following the initial transmission of the TB.

In another example, HARQ feedback with confidence indicator can be applied at the TB level or code-block or code-block-group (CBG) level. If configured for CBG-level, the number of bits in HARQ feedback is expected to increase compared to TB-level feedback.

In another embodiment, the configuration indication received by the UE includes information regarding how many bits or how many levels of information to be included in the confidence indicator or measurement report/outcome. For example, a confidence indicator comprising N levels would require log₂N bits. In one example, HARQ feedback may comprise M bits which could provide log₂M different feedback information, where M is greater than N. In one example, one of the log₂M combinations indicates an ACK and the remaining log₂M−1 combinations indicate NACK with various level of confidence information.

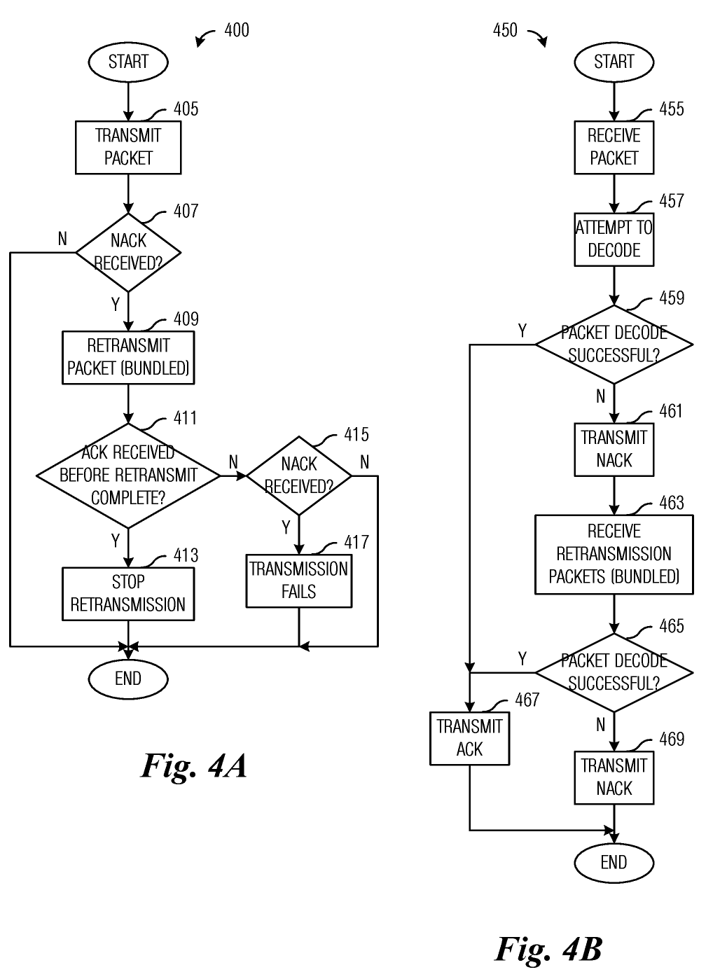

FIG. 4A illustrates a flow diagram of example operations 400 occurring in a transmission point communicating with a reception point using URLLC. Operations 400 may be indicative of operations occurring in a transmission point, such as an AN in a downlink transmission or a UE in an uplink transmission, as the transmission point communicates with a reception point.

Operations 400 begin with the transmission point transmitting a packet (block 405). The packet may be transmitted to a reception point, a group of reception points including the reception point, or broadcast. The transmission point performs a check to determine if a NACK corresponding to the transmission of the packet is received (block 407). If a NACK is not received, i.e., an ACK is received, the packet has been successfully received and operations 400 end.

If a NACK is received, the transmission point retransmits the packet multiple times (block 409). In other words, the transmission point bundles the retransmission of the packet, sending multiple repeat packets. The multiple retransmissions of the packet may occur in a succession of transmission opportunities, such as a sequence of downlink transmission opportunities or a sequence of uplink transmission opportunities. In an example embodiment, the NACK includes a confidence indicator that indicates the reception point's confidence in the decoding result, or the NACK includes a measurement report/outcome of processing of information, which is related to the confidence in the decoding result. The confidence in the decoding result may be based on the quality of the link between the transmission point and the reception point, for example. As an example, the confidence indicator may be a quantized value that indicates how much confidence the reception point has in the decoding. As an example, the confidence indicator may be a 5 valued indicator: very confident, moderately confident, neutral, moderately not confident, very not confident. The transmission point may determine the number of retransmissions to make based on the confidence indicator. As an example, if the confidence indicator is very confident, the transmission point makes a single retransmission of the packet, while if the confidence indication is very not confident, the transmission point makes as many retransmissions of the packet as possible. In another example embodiment, the confidence indicator is a numerical value representing a SNR, SINR, LLR, reference signal received power (RSRP), reference signal received quality (RSRQ), and so forth, of the link between the transmission point and the reception point. In another example embodiment, the confidence indicator is a numerical value representing decoder status information, such as LLR.

In another example embodiment, the transmission point determines its own confidence indicator based on reports from the reception point. As an example, the reception point periodically feeds back SNR, SINR, LLR, RSRP, RSRQ, and so forth, and the transmission point determines its own confidence indicator based on the feedback. As another example, the transmission point determines its own confidence indicator based on historical information, such as previous transmission failures or successes. As another example, the transmission point receives historical information from other devices (transmission points and/or reception points) related to their own transmission/reception failures or successes. As in the situation with the confidence indicator from the reception point, the transmission point may determine the number of retransmissions to make based on the confidence indicator.

In another example embodiment, the number of retransmissions the transmission point is to make when a NACK is received may be pre-configured, specified in a technical standard or by an operator of the communications system. In another example embodiment, the transmission point and the reception point communicate to determine the number of retransmissions.

The transmission point performs a check to determine if an ACK corresponding to at least one of the retransmissions is received prior to the completion of the multiple retransmissions (block 411). If the ACK is received before all of the retransmissions is complete, the transmission point stops any remaining retransmissions (block 413) and operations 400 end. If the ACK is not received before all of the retransmission is complete, the transmission point performs a check to determine if a NACK is received (block 415). If a NACK is received, then the transmission fails (block 417) and operations 400 end. If a NACK is not received, operations 400 end.

In an embodiment, in a situation where latency is not a significant issue, a transmission point may continue to schedule bundled retransmissions until an ACK is received from the reception point. Such an embodiment may be advantageous in deployments where frequent monitoring of resource grants or A/N feedback may negatively impact energy consumption, for example. As an example, a reception point feeds back a NACK after it has unsuccessfully decoded a bundled retransmission of a packet. The transmission point schedules another bundled retransmission upon receipt of the NACK. A maximum number of times the transmission point will continue to schedule bundled retransmissions may be specified by a technical standard, or preconfigured, e.g., by RRC.

In another embodiment, the transmission point schedules an indefinite number of bundled retransmissions and will abort any uncompleted bundled retransmissions upon receipt of an ACK. In this embodiment, a single NACK will trigger the bundled retransmissions, which will stop upon receipt of an ACK.

FIG. 4B illustrates a flow diagram of example operations 450 occurring in a reception point communicating with a transmission point using URLLC. Operations 450 may be indicative of operations occurring in a reception point, such as an AN in an uplink transmission or a UE in a downlink transmission, as the reception point communicates with a transmission point.

Operations 450 begin with the reception point receiving a packet (block 455). The reception point attempts to decode the packet (block 457). The reception point performs a check to determine if the decoding of the packet was successful (block 459). If the decoding of the packet was not successful, the reception point transmits a NACK to the transmission point (block 461). The NACK may include a confidence indicator, as discussed previously. The reception point receives multiple retransmissions of the packet (block 463). As each retransmission is received, the reception point attempts to decode the retransmission, and if the decoding of the retransmission is successful (block 465), the reception point transmits an ACK (block 467) and operations 450 end. It is noted that the decoding may involve the combining of the multiple instances of the packet and joint decoding to help improve decoding performance. If all of the decoding attempts of the multiple retransmissions of the packets fail, the reception point transmits a NACK (block 469) and operations 450 end. If the decoding of the packet in block 457 succeeds, the reception point transmits an ACK (block 467) and operations 450 end.

In an embodiment, the transmission point is configured to reschedule bundled retransmissions until the reception point sends an ACK. Therefore, in a situation when the reception point sends a NACK, the reception point knows to expect additional bundled retransmissions, until the reception point sends an ACK to the transmission point. A maximum number of times the transmission point will continue to schedule bundled retransmissions may be specified by a technical standard, or preconfigured.

In another embodiment, the transmission point schedules an indefinite number of bundled retransmissions and will abort any uncompleted bundled retransmissions upon receipt of an ACK, so the reception point knows to expect an indefinite number of bundled retransmissions until it sends an ACK. In this embodiment, a single NACK will trigger the bundled retransmissions, which will stop upon receipt of an ACK.

FIG. 5 illustrates an example DL-dominated URLLC TDD frame structure 500, highlighting bundled retransmissions triggered by a NACK. As shown in FIG. 5, the bundled retransmissions are triggered by the reception of a NACK. On the other hand, if an acknowledgment (ACK) is received, the packet transmission is considered to have been completed successfully.

An initial downlink packet is transmitted by an AN in a downlink portion 505 of DL-dominated URLLC TDD frame structure 500. The UE receives the initial downlink packet but is unable to decode the initial downlink packet and transmits a NACK in an uplink portion 507, which is the first uplink transmission opportunity of DL-dominated URLLC TDD frame structure 500. Because the NACK is received in uplink portion 507, the AN may not able to begin the bundled retransmission of the packet in the next downlink portion. Instead, the bundled retransmission of the packet commences in downlink portion 509, followed by downlink portions 511, 513, and 515. As discussed previously, the number of retransmissions in the bundled retransmission may dependent upon the confidence indicator provided by the UE (in the NACK, for example) or by the AN (based on feedback provided by the UE, for example), preconfigured, or a specified by a technical standard or operator of the communications system.

As the UE receives the retransmissions of the packet in the bundled retransmission, the UE attempts to decode the packet. In an example embodiment, the multiple instances of the received packet are combined and joint decoding is performed by the UE to improve decoding performance. It is therefore, possible for the UE to successfully decode the packet prior to receiving all of the bundled retransmissions. In such a situation, the UE may generate and transmit an ACK, which causes the AN stop any retransmission of the packet not yet performed.

The number of slots that are aggregated for the initial packet transmission and the retransmissions may be indicated in downlink control information for a scheduled downlink transmission. In the uplink, if scheduled uplink transmissions are utilized, the number of slots aggregated for the initial packet transmission and the retransmissions may also be indicated in downlink control information. If uplink transmissions are grant-free, then the number of slots aggregated for the initial packet transmission and the retransmissions may be pre-configured or indicated in downlink control information. As an example, when an uplink transmission point receives a A/N in the downlink, the downlink control may include information regarding the bundled retransmissions along with information about the A/N.

According to an example embodiment, the transmission point helps to improve the reliable message delivery rate by automatically retransmitting one or more instances of the packet prior to receiving an A/N of any form from the reception point. The automatic retransmission of the packet(s) may be referred to as acknowledgement-less retransmission. The number of packets automatically retransmitted may be pre-configured or determined based on feedback received from the reception point (such as SNR, SINR, RSRP, RSRQ, LLR, and so on), confidence indicators, recent (historical) A/N performance of transmissions to the reception point, a technical standard, an operator of the communications system, communications involving the transmission point and the reception point, and so forth. As an example, if the confidence indicator indicates very confident, there may be 0 automatic retransmissions, while if the confidence indicator indicates very not confident, the maximum number of automatic retransmissions may be performed.

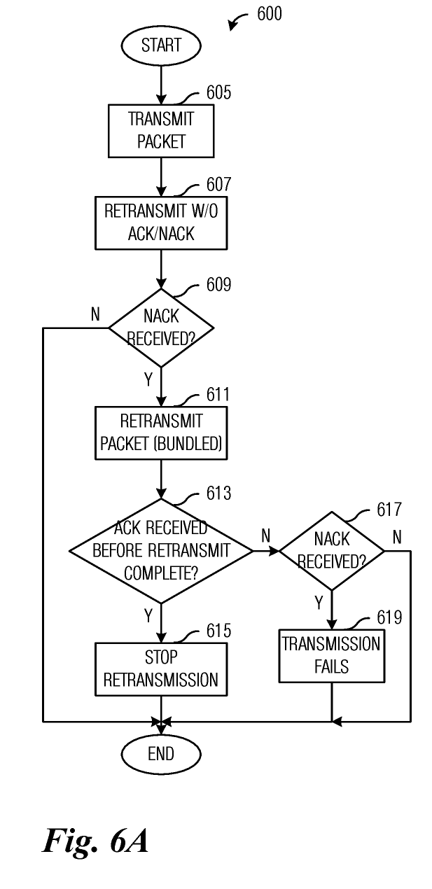

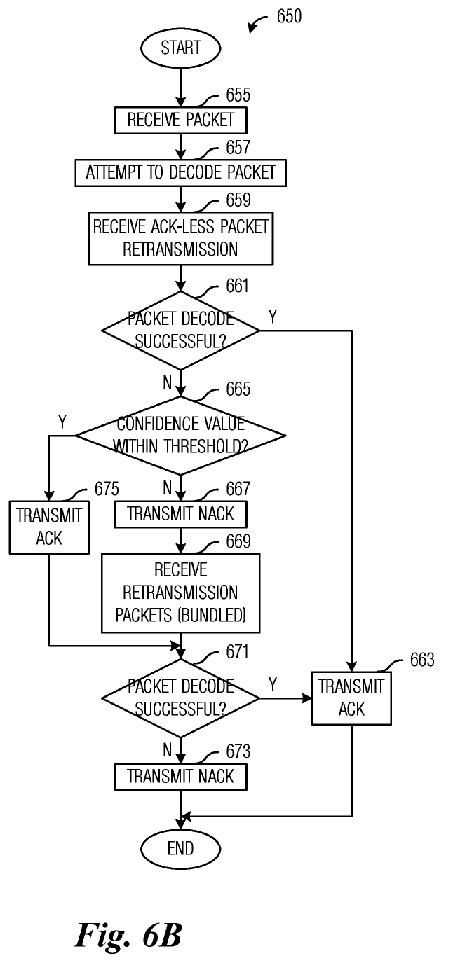

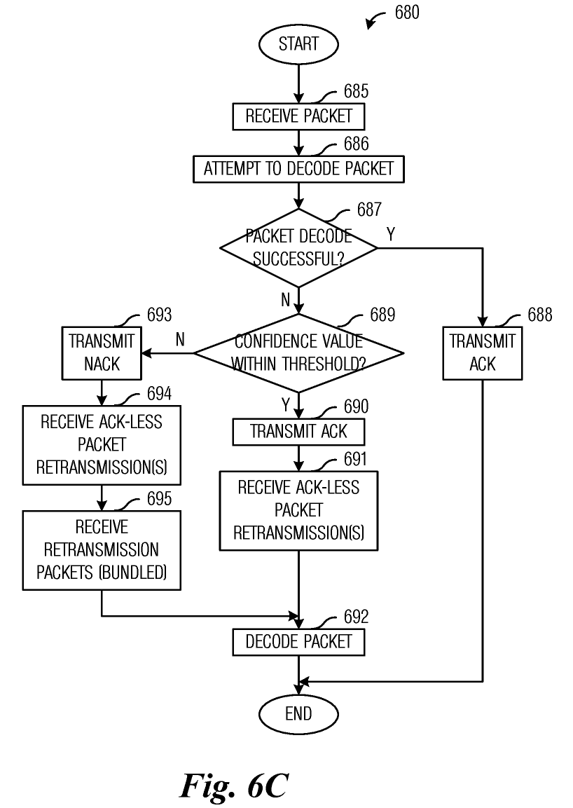

FIG. 6A illustrates a flow diagram of example operations 600 occurring in a transmission point communicating with a reception point using URLLC with acknowledgement-less retransmissions. Operations 600 may be indicative of operations occurring in a transmission point, such as an AN in a downlink transmission or a UE in an uplink transmission, as the transmission point communicates with a reception point.

Operations 600 begin with the transmission point transmitting a packet (block 605). The packet may be transmitted to a reception point, a group of reception points including the reception point, or broadcast. The transmission point also automatically performs acknowledgement-less retransmissions (block 607). The number of retransmissions of such “blind repeat” packets in acknowledgement-less retransmissions may be dependent on the confidence indicator or other information. The number of retransmissions may range from 0 to a maximum number of retransmissions, which may be dependent on the frame structure of the communications system, for example. The transmission point performs a check to determine if a NACK corresponding to the transmission of the packet is received (block 609). If a NACK is not received, i.e., an ACK is received, the packet has been successfully received and operations 600 end.

If a NACK is received, the transmission point retransmits the packet multiple times (block 611). In other words, the transmission point bundles the retransmission of the packet. The multiple retransmissions of the packet may occur in a succession of transmission opportunities, such as a sequence of downlink transmission opportunities or a sequence of uplink transmission opportunities. The transmission point performs a check to determine if an ACK corresponding to at least one of the retransmissions is received prior to the completion of the multiple retransmissions (block 613). If the ACK is received before all of the retransmissions is complete, the transmission point stops any remaining retransmissions (block 615) and operations 600 end. If the ACK is not received before all of the retransmission is complete, the transmission point performs a check to determine if a NACK is received (block 617). If a NACK is received, then the transmission fails (block 619) and operations 600 end. If a NACK is not received, operations 600 end.

FIG. 6B illustrates a flow diagram of example operations 650 occurring in a reception point communicating with a transmission point using URLLC with acknowledgement-less retransmissions. Operations 650 may be indicative of operations occurring in a reception point, such as an AN in an uplink transmission or a UE in a downlink transmission, as the reception point communicates with a transmission point.

Operations 650 begin with the reception point receiving a packet (block 655). The reception point attempts to decode the packet (block 657). The reception point receives at least one acknowledgment-less retransmission (block 659) of a blind repeat packet. The number of acknowledgment-less retransmissions may range from 0 to a maximum number of retransmissions. The reception point performs a check to determine if the packet decoding was successful (block 661). The packet decoding being checked involves the decoding of the packet received in block 655. If the packet decoding was successful, the reception point transmits an ACK (block 663) and operations 650 end.

If the packet decoding was unsuccessful, the reception point performs a check to determine if a confidence value is within a specified threshold (block 665). The confidence value may be related to a quality of the link between the transmission point and the reception point, such as the SNR, SINR, RSRP, RSRQ, LLR, and so forth, while the specified threshold may be specified by a technical standard, an operator of the communications system, agreed upon by the transmission point and the reception point, pre-configured, and so on. The confidence value may also be related to decoder status information, e.g., LLR. The comparison of the confidence value and the specified threshold enables the reception point to determine if the quality of the link is high enough that there is reasonable confidence that with the combining of the acknowledgement-less retransmissions, the reception point will be able to successfully decode the packet. The comparison of the confidence value and the specified threshold also enables the reception point to determine if the decoder status information is high enough that there is reasonable confidence that with the combining of the acknowledgement-less retransmissions, the reception point will be able to successfully decode the packet. In other words, the reception point is considering if it will be able to decode the packet if joint decoding is performed with the packet and the retransmitted packet(s) received during automatic acknowledgement-less retransmission. If there is reasonable confidence, the reception point will not request retransmissions of the packet by transmitting an ACK.

The confidence value may enable the reception point to reduce the number of retransmissions made by the transmission point by preemptively transmitting an ACK, even prior to fully decoding the packet, for example. Further examples of reception points using the confidence value are provided below.

If the confidence value is not within the specified threshold, the reception point transmits a NACK (block 667) and receives multiple retransmissions of the packet (block 669). As each retransmission is received, the reception point attempts to decode the retransmission, and if the decoding of the retransmission is successful (block 671), the reception point transmits an ACK (block 663) and operations 650 end. It is noted that the decoding may involve the combining of the multiple instances of the packet and joint decoding to help improve decoding performance. If all of the decoding attempts of the multiple retransmissions of the packets fail, the reception point transmits a NACK (block 673) and operations 650 end.

If the confidence value is within the specified threshold, the reception point transmits an ACK (block 675) and attempts to decode a combined version of the multiple instances of the packet (including the packet received in block 655 and the retransmissions of the packet in block 659) and performs a check to determine if the packet decoding is successful (block 671). This behavior may be referred to as optimistic decoding. If the decoding of the retransmission is successful, the reception point transmits an ACK (block 663) and operations 650 end. If the decoding of the retransmission is not successful, the reception point transmits an ACK (block 673) and operations 650 end.

FIG. 6C illustrates a flow diagram of example operations 680 occurring in a reception point using acknowledgement-less retransmissions and confidence value to reduce a number of A/Ns transmitted. Operations 680 may be indicative of operations occurring in a reception point as the reception point uses acknowledgement-less retransmissions and confidence values to reduce a number of A/Ns transmitted.

Operations 680 begin with the reception point receiving a packet (block 685). The reception point attempts to decode the packet (block 686). The reception point performs a check to determine if the packet decoding was successful (block 687). The packet decoding being checked involves the decoding of the packet received in block 685. If the packet decoding was successful, the reception point transmits an ACK (block 688) and operations 680 end.

If the packet decoding was unsuccessful, the reception point performs a check to determine if a confidence value is within a specified threshold (block 689). The confidence value may be related to a quality of the link between the transmission point and the reception point, such as the SNR, SINR, RSRP, RSRQ, and so forth, or decoder status information, e.g., LLR, while the specified threshold may be specified by a technical standard, an operator of the communications system, agreed upon by the transmission point and the reception point, pre-configured, and so on.

Although the packet decoding was unsuccessful, if the confidence value is within the specified threshold, the reception point transmits an ACK (block 690). This is counter to the normal function of an ACK, which typically indicates that the packet decoding was successful. However, the reception point knows that the transmission point is automatically making acknowledgement-less retransmissions and if the confidence value is sufficiently high (thereby indicating that there is good confidence in the channel quality feedback information or decoder status information) that by combining the received packet with one or more acknowledgment-less retransmissions of the packet will enable the reception point to successfully decode the packet. The reception point receives the acknowledgement-less retransmission(s) (block 691) and decode the packet (block 692). It is noted that the reception of the ACK at the transmission point may result in the cancellation of any pending acknowledgement-less retransmissions. However, due to the structure of the acknowledgement-less retransmissions, at least some of the acknowledgement-less retransmissions will be transmitted prior to the transmission point receives the ACK.

If the packet decoding was unsuccessful and if the confidence value is not within the specified threshold, the reception point transmits a NACK (block 693) and receives the acknowledgment-less retransmission(s) (block 694) and the retransmission packets (block 695). The reception point decodes the packet, which may be a combination of the packet, the acknowledgement-less retransmission(s), and the retransmission packets (block 692).

Additional embodiments may include error handling for situations when the decoding of the packet in block 692 fail.

In an embodiment, the reception point automatically sends an ACK if the confidence value is within the threshold, even before attempting to decode the packet or before an attempt to decode the packet completes. As discussed previously, if the confidence value is within the threshold, there is good reason to expect that the reception point will be able to successfully decode the packet, either initially, or with the combination of at least some of the acknowledgement-less retransmissions.

In an embodiment, the number of ACK-less retransmissions configured or scheduled in block 691 may be less than the number of ACK-less retransmissions configured or scheduled in block 695.

In an embodiment, the confidence value has different levels. As discussed above, the value can be very confident, moderately confident, neutral, moderately not confident, not very confident. All of the operations explained above can be extended to show multi-level feedback, instead of binary feedback of ACK and NACK depending on a threshold. For example, if outcome is moderately confident, then number of (configured) bundled retransmissions received may be more than if it were very confident. It is noted that in a situation where multi-level/multi-bit feedback is utilized, the decision blocks of the flow diagrams presented herein may have more than two outcomes. For each outcome, an appropriate retransmission technique (such as those described herein) may be utilized.

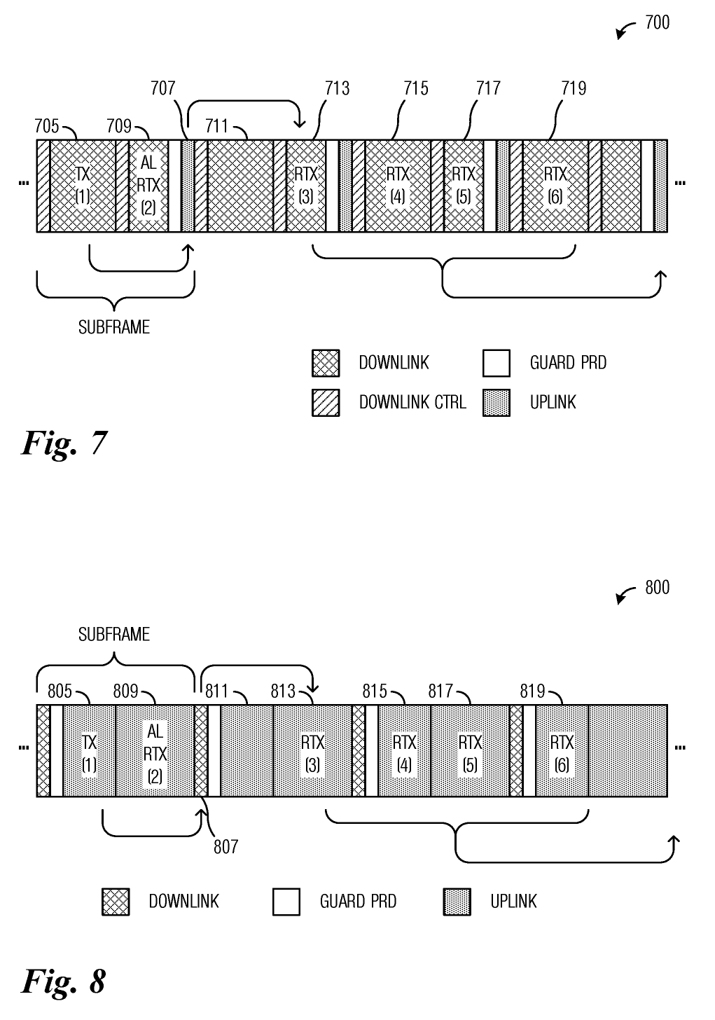

FIG. 7 illustrates an example DL-dominated URLLC TDD frame structure 700, highlighting automatic acknowledgement-less (AL) retransmission and bundled retransmissions triggered by a NACK. An initial downlink packet is transmitted by an AN in a downlink portion 705 of DL-dominated URLLC TDD frame structure 700. The UE receives the initial downlink packet and transmits an A/N in an uplink portion 707, which is the first uplink transmission opportunity of DL-dominated URLLC TDD frame structure 700.

In addition to the initial downlink packet transmitted in downlink portion 705, the AN also performs automatic acknowledgement-less retransmission, which means that the AN may retransmit the packet at least one time prior to receiving an A/N from the UE. As shown in FIG. 7, the AN retransmits the packet a single time in downlink portion 709. It is noted that such a blind retransmission, that is, the automatic acknowledgement-less retransmission, occurs even before the AN receives the A/N from the UE in uplink portion 707. Although shown in FIG. 7 as making a single automatic acknowledgment-less retransmission, the AN may make more than one retransmissions without receiving the A/N from the UE. Furthermore, the single automatic acknowledgment-less retransmission is shown in FIG. 7 as occurring before the AN receives the A/N from the UE, the AN may also make an additional retransmission in downlink portion 711 (which is not illustrated as taking place in FIG. 7), which is after receiving the A/N from the UE in uplink portion 707.

For discussion purposes, consider a situation where the UE was unable to decode the packet transmitted in downlink portion 705. Therefore, the UE transmits a NACK in the A/N transmitted in uplink portion 707. Because the NACK is received in uplink portion 707, the AN may not be able to begin the bundled retransmission of the packet, that is, transmission of repeat packet(s), in the next downlink portion. Instead, the bundled retransmission of the packet commences in downlink portion 713, followed by downlink portions 715, 717, and 719. As discussed previously, the number of retransmissions in the bundled retransmission may dependent upon the confidence indicator provided by the UE (in the NACK, for example) or by the AN (based on feedback provided by the reception point, for example), pre-configured, or a specified by a technical standard or operator of the communications system.

As discussed previously, even if the UE is not able to decode the packet received in downlink portion 705, if the confidence value is within the specified threshold, the UE may still transmit an ACK in the A/N transmitted in uplink portion 707 and perform optimistic decoding with the packet received in downlink portion 705 and the at least one automatic acknowledgement-less retransmission received in downlink portion 709. If the optimistic decoding performed by the UE is successful, the UE may transmit an ACK in a subsequent uplink portion to stop the AN from making any additional retransmissions.

FIG. 8 illustrates an example UL-dominated URLLC TDD frame structure 800, highlighting automatic acknowledgement-less retransmission and bundled retransmissions triggered by a NACK. An initial uplink packet is transmitted by a UE in an uplink portion 805 of UL-dominated URLLC TDD frame structure 800. The AN receives the initial uplink packet and transmits a A/N based on the decoding of the initial uplink packet in an downlink portion 807, which is the first downlink transmission opportunity of UL-dominated URLLC TDD frame structure 800.

In addition to the initial uplink packet transmitted in uplink portion 805, the UE also performs automatic acknowledgement-less retransmission, which means that the UE may retransmit the packet at least one time prior to receiving an A/N from the AN. As shown in FIG. 8, the UE retransmits the packet a single time in uplink portion 809. It is noted that the automatic acknowledgement-less retransmission occurs even before the UE receives the A/N from the AN in downlink portion 807. Although shown in FIG. 8 as making a single automatic acknowledgment-less retransmission, the UE may make more than one retransmissions without receiving the A/N from the AN. Furthermore, the single automatic acknowledgment-less retransmission is shown in FIG. 8 as occurring before the UE receives the A/N from the AN, the UE may also make an additional retransmission in uplink portion 811 (which is not illustrated as taking place in FIG. 8).

Consider where the AN was unable to decode the packet transmitted in uplink portion 805. Therefore, the AN transmits a NACK in the A/N transmitted in downlink portion 807. Because the NACK is received in downlink portion 807, the UE may not be able to begin the bundled retransmission of the packet in the next uplink portion. In such a situation, the bundled retransmission of the packet commences in uplink portion 813, followed by uplink portions 815, 817, and 819. As discussed previously, the number of retransmissions in the bundled retransmission may be dependent upon the confidence indicator provided by the AN (in the NACK, for example) or by the UE (based on feedback provided by the AN, for example), pre-configured, or specified by a technical standard or operator of the communications system.

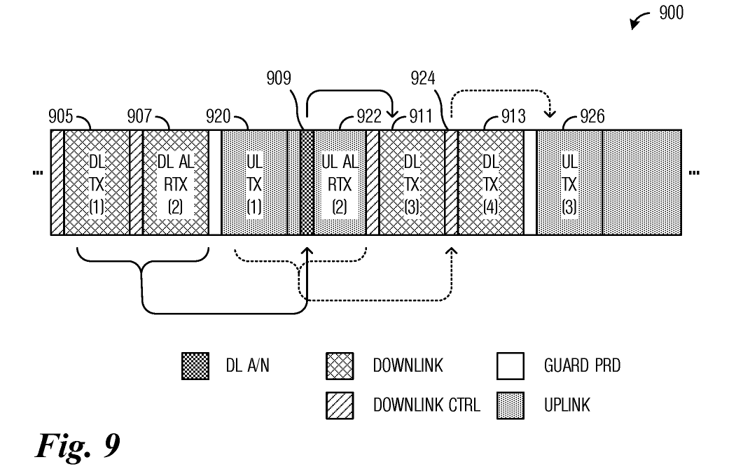

FIG. 9 illustrates an example bidirectional URLLC TDD frame structure 900, highlighting automatic acknowledgement-less retransmission and bundled retransmissions triggered by a NACK. An initial downlink packet is transmitted by an AN in a downlink portion 905 of bidirectional URLLC TDD frame structure 900. The UE receives the initial downlink packet and transmits an A/N based on the decoding of the initial downlink packet in an uplink portion 909. In addition to the initial downlink packet transmitted in downlink portion 905, the AN also performs automatic acknowledgement-less retransmission, which means that the AN may retransmit the packet at least one time prior to receiving an A/N from the UE. As shown in FIG. 9, the AN retransmits the packet a single time in downlink portion 907. It is noted that the automatic acknowledgement-less retransmission occurs even before the AN receives the A/N from the UE in uplink portion 909. It is noted that the AN transmitted in uplink portion 909 may not occupy the full transmission symbol. As an example, the A/N may be FDM multiplexed with data in a transmission symbol. As with the DL-dominated URLLC TDD frames, the AN may make more than one retransmissions without receiving the A/N from the UE.

Consider that the UE was unable to decode the packet transmitted in downlink portion 905. Therefore, the UE transmits a NACK in the A/N transmitted in uplink portion 909. The bundled retransmission of the packet commences in downlink portion 911, followed by downlink portion 913. As discussed previously, the number of retransmissions in the bundled retransmission may be dependent upon the confidence indicator provided by the UE (in the NACK, for example) or by the AN (based on feedback provided by the UE, for example), pre-configured, or specified by a technical standard or operator of the communications system.

An initial uplink packet is transmitted by a UE in an uplink portion 920 of bidirectional URLLC TDD frame structure 900. The AN receives the initial uplink packet and transmits an A/N based on the decoding of the initial uplink packet in a downlink portion 924. In addition to the initial uplink packet transmitted in uplink portion 920, the UE also performs automatic acknowledgement-less retransmission, which means that the UE may retransmit the packet at least one time prior to receiving an A/N from the AN. As shown in FIG. 9, the UE retransmits the packet a single time in uplink portion 922. It is noted that the automatic acknowledgement-less retransmission occurs even before the UE receives the A/N from the AN in downlink portion 924. As with the UP-dominated URLLC TDD frames, the UE may make more than one retransmissions without receiving the A/N from the AN.

Consider that the AN was unable to decode the packet transmitted in uplink portion 920. Therefore, the AN transmits a NACK in the A/N transmitted in downlink portion 924. The bundled retransmission of the packet commences in downlink portion 926, and may be followed additional downlink transmissions. As discussed previously, the number of retransmissions in the bundled retransmission may be dependent upon the confidence indicator provided by the AN (in the NACK, for example) or by the UE (based on feedback provided by the AN, for example), pre-configured, or specified by a technical standard or operator of the communications system.

Various combinations of the techniques presented herein in the discussion of the example embodiments are possible, therefore the explicit discussion of a small number of combinations should not be construed as being limiting to either the scope or the spirit of the example embodiments. As an illustrative example, an AN may make use of both automatic acknowledgement-less retransmission and bundled retransmissions triggered by a NACK, while a corresponding UE used neither. As another illustrative example, both an AN and a corresponding uses both automatic acknowledgement-less retransmission and bundled retransmissions triggered by a NACK. As yet another illustrative example, an AN may make use of both automatic acknowledgement-less retransmission and bundled retransmissions triggered by a NACK, while a corresponding UE uses only bundled retransmissions triggered by a NACK. Other example combinations are possible.

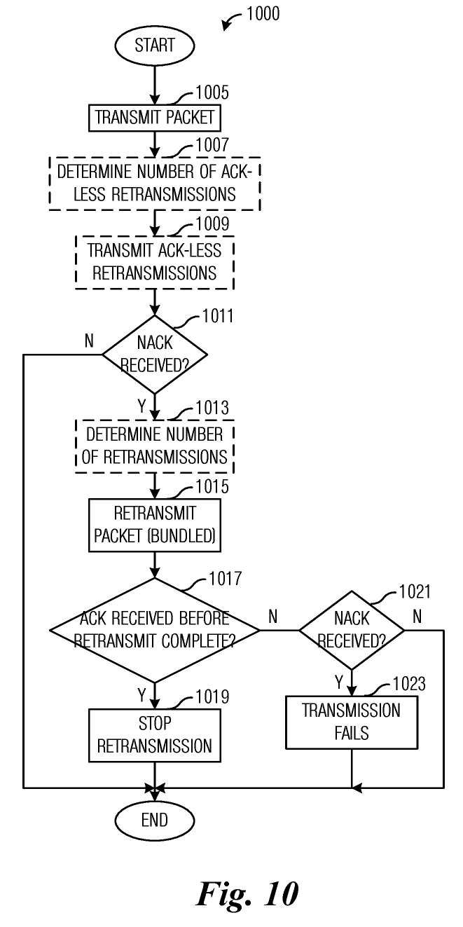

FIG. 10 illustrates a flow diagram of example operations 1000 occurring in an AN transmitting a packet with support for reliable transmission. Operations 1000 may be indicative of operations occurring in an AN as the AN transmits a packet with support for reliable transmission.

Operations 1000 begin with the AN transmitting a packet to a UE (block 1005). Optionally, if the AN is performing acknowledgement-less retransmissions, the AN may determine a number of acknowledgement-less retransmissions (block 1007) and transmits the acknowledgement-less retransmissions (block 1009). The number of acknowledgement-less retransmissions may be in accordance with a confidence indicator, which may be previously received in feedback. Alternatively, the number of acknowledgement-less retransmissions may be determined from channel quality feedback information (such as SNR, SINR, RSRP, RSRQ, and so on) or decoder status information (e.g., LLR) received from the UE or other UE(s) operating in close proximity to the UE. Alternatively, the number of acknowledgement-less retransmissions may be determined from historical information, such as successful/unsuccessful transmissions to the UE or other UE(s) operating in close proximity to the UE, and so on. The AN performs a check to determine if a NACK corresponding to the transmission of the packet is received (block 1011). If a NACK is not received, i.e., an ACK is received, the packet has been successfully received and operations 1000 end.

If a NACK is received, the transmission point optionally determines a number of retransmissions (block 1013). The number of retransmissions may be in accordance with a confidence indicator, which may be previously received in feedback. Alternatively, the number of retransmissions may be determined from channel quality feedback information (such as SNR, SINR, RSRP, RSRQ, and so on) or decoder status information (e.g., LLR) received from the UE or other UE(s) operating in close proximity to the UE. Alternatively, the number of retransmissions may be determined from historical information, such as successful/unsuccessful transmissions to the UE or other UE(s) operating in close proximity to the UE, and so on. The AN retransmits the packet multiple times (block 1015). The transmission point performs a check to determine if an ACK corresponding to at least one of the retransmissions is received prior to the completion of the multiple retransmissions (block 1017). If the ACK is received before all of the retransmissions is complete, the transmission point stops any remaining retransmissions (block 1019) and operations 1000 end. If the ACK is not received before all of the retransmission is complete, the transmission point performs a check to determine if a NACK is received (block 1021). If a NACK is received, then the transmission fails (block 1023) and operations 1000 end. If a NACK is not received, operations 1000 end.

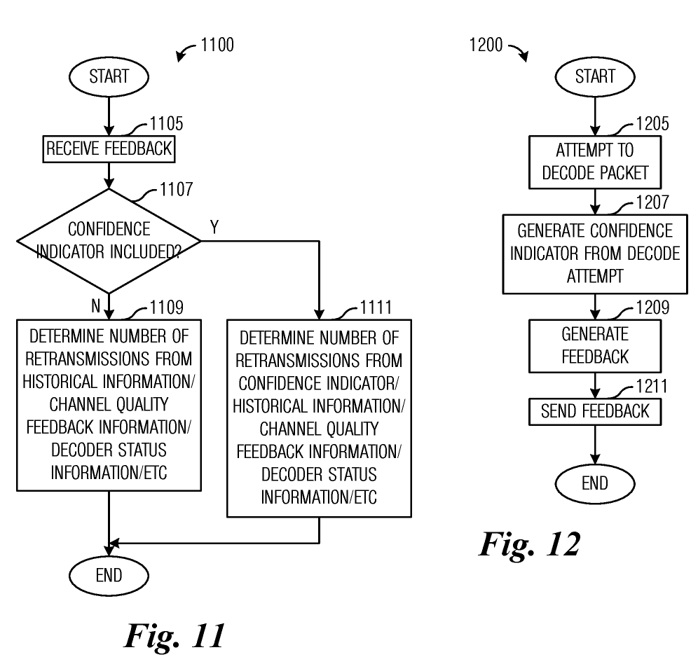

FIG. 11 illustrates a flow diagram of example operations 1100 occurring in an AN determining a number of retransmissions in accordance with a confidence indicator and/or feedback. Operations 1100 may be indicative of operations occurring in an AN as the AN determines a number of retransmissions in accordance with a confidence indicator and/or feedback.

Operations 1100 begin with the AN receiving feedback from a UE (block 1105). The AN performs a check to determine if a confidence indicator is included with the feedback (block 1107). If the feedback does not include a confidence indicator, the AN determines a number of retransmissions of a packet in accordance with historical information, channel quality feedback information, and/or decoder status information (block 1109). As an example, the number of retransmissions may be determined from channel quality feedback information (such as SNR, SINR, RSRP, RSRQ, and so on) or decoder status information (e.g., LLR) received from the UE or other UE(s) operating in close proximity to the UE. As another example, the number of retransmissions may be determined from historical information, such as successful/unsuccessful transmissions to the UE or other UE(s) operating in close proximity to the UE, and so on. As yet another example, the number of retransmissions may be determined from a combination of channel quality feedback information, decoder status information, and historical information. If the feedback does include a confidence indicator, the AN determines the number of retransmissions in accordance with the confidence indicator, historical information, channel quality feedback information, and/or decoder status information (block 1111). As an example, the number of retransmissions may be determined from the confidence indicator alone. As another example, the number of retransmissions may be determined from the confidence indicator and one, two, or all of the channel quality feedback information, decoder status information, and historical information. It is noted that number of retransmissions may be for the number of acknowledgement-less retransmissions and/or the number of retransmissions. It is also noted that the AN may determine different values for the number of acknowledgement-less retransmissions and the number of retransmissions, or use the same number of retransmissions for both.

FIG. 12 illustrates a flow diagram of example operations 1200 occurring in a UE providing feedback. Operations 1200 may be indicative of operations occurring in a UE as the UE provides feedback.

Operations 1200 begin with the UE attempting to decode a received packet (block 1205). The UE generates a confidence indicator from the decode attempt (block 1207). As an example, if the decoding attempt was successful, the UE may generate a high confidence indicator, while if the decoding attempt was unsuccessful, the UE may generate a low confidence indicator. As another example, the UE uses a sliding window of multiple decoding attempt results to generate the confidence indicator to help reduce the impact of transient noise and/or interference on the confidence indicator. As another example, the UE increments the confidence indicator by a first specified value if the decoding attempt was successful and decrements the confidence indicator by a second specified value if the decoding attempt was unsuccessful. The first specified value and the second specified value may be specified in a technical standard, by an operator of the communications system, or determined through collaboration between the UE and the AN. The first specified value and the second specified value may or may not be equal. There may be a maximum and/or a minimum value for the confidence indicator. The maximum and/or minimum value may be specified in a technical standard, by an operator of the communications system, or determined through collaboration between the UE and the AN. The UE generates feedback (block 1209). The feedback includes the confidence indicator. The UE sends the feedback (block 1211).

### EXAMPLE EMBODIMENTS

The following provides a non-limiting list of example embodiments of the present disclosure:

In a first aspect, the present application provides a method for communications. The method includes transmitting, by a TP, a data packet to a RP, and transmitting, by the TP, a number of repeat packets in accordance with a first decoding indicator indicating that the data packet was unsuccessfully decoded, wherein the number is at least two.

According to a first embodiment of the method according to the first aspect, the method includes transmitting, by the TP, at least one blind repeat packet prior to receiving the first decoding indicator.

According to a second embodiment of the method according to any preceding embodiment of the first aspect or the first aspect as such, wherein the at least one blind repeat packet is transmitted automatically after transmitting the data packet.

According to a third embodiment of the method according to any preceding embodiment of the first aspect or the first aspect as such, wherein the data packet and the blind repeat packet contain same data.

According to a fourth embodiment of the method according to any preceding embodiment of the first aspect or the first aspect as such, wherein the first decoding indicator comprises a confidence indicator indicating a confidence level of the RP in decoding the data packet, and wherein a number of repeat packets transmitted is in accordance with the confidence level.

According to a fifth embodiment of the method according to any preceding embodiment of the first aspect or the first aspect as such, wherein the number of repeat packets transmitted is in accordance with a confidence value derived from feedback received by the TP.

According to a sixth embodiment of the method according to any preceding embodiment of the first aspect or the first aspect as such, wherein the feedback comprises at least one of a SNR, a SINR, a LLR value, RSRP, or RSRQ, of a link between the TP and the RP.

According to a seventh embodiment of the method according to any preceding embodiment of the first aspect or the first aspect as such, wherein the first decoding indicator comprises a NACK.

According to an eighth embodiment of the method according to any preceding embodiment of the first aspect or the first aspect as such, wherein the data packet and the repeat packets contain same data.

According to a ninth embodiment of the method according to any preceding embodiment of the first aspect or the first aspect as such, wherein the data packet and the number of the repeat packets are transmitted in a time division duplexed (TDD) communications system.

According to a fourth embodiment of the method according to any preceding embodiment of the first aspect or the first aspect as such, the method includes receiving, by the TP, a second decoding indicator indicating that the data packet was successfully decoded, and stopping, by the TP, a remaining incomplete transmission of the repeat packets.

In a second aspect, the present application provides a method for communications. The method includes receiving, by a RP, a data packet from a TP, transmitting, by the RP, a first decoding indicator indicating that the data packet was unsuccessfully decoded, and receiving, by the RP, at least two repeat packets from the RP.

According to a first embodiment of the method according to the second aspect, the method includes receiving, by the RP, at least one blind repeat packet prior to transmitting the first decoding indicator.

According to a second embodiment of the method according to any preceding embodiment of the second aspect or the second aspect as such, wherein the data packet and the blind repeat packet contain same data.

According to a third embodiment of the method according to any preceding embodiment of the second aspect or the second aspect as such, wherein the first decoding indicator comprises a confidence indicator indicating a confidence level of the RP in decoding the data packet.

According to a fourth embodiment of the method according to any preceding embodiment of the second aspect or the second aspect as such, the method includes transmitting, by the RP, feedback regarding a link between the RP and the TP.

According to a fifth embodiment of the method according to any preceding embodiment of the second aspect or the second aspect as such, wherein the feedback comprises at least one of a signal to noise ratio (SNR), a signal plus interference to noise ratio (SINR), log likelihood ratio (LLR) values, reference signal received power (RSRP), or reference signal received quality (RSRQ), of the link.

According to a sixth embodiment of the method according to any preceding embodiment of the second aspect or the second aspect as such, wherein the data packet and the repeat packets contain same data.

According to a seventh embodiment of the method according to any preceding embodiment of the second aspect or the second aspect as such, the method includes attempting, by the RP, to decode the data packet in conjunction with at least one of the repeat packets, and transmitting, by the RP, a second decoding indicator indicating that the data packet was unsuccessfully decoded.

In a third aspect, the present application provides a TP adapted to perform communications. The TP includes a processor, and a computer readable storage medium storing programming for execution by the processor. The programming including instructions to configure the TP to transmit a data packet to a RP, and transmit a number of repeat packets in accordance with a first decoding indicator indicating that the data packet was unsuccessfully decoded, wherein the number is at least two.

According to a first embodiment of the TP according to the third aspect, wherein the programming includes instructions to configure the TP to transmit at least one blind repeat packet prior to receiving the first decoding indicator.

According to a second embodiment of the TP according to any preceding embodiment of the third aspect or the third aspect as such, wherein the at least one blind repeat packet is transmitted automatically after transmitting the data packet.

According to a third embodiment of the TP according to any preceding embodiment of the third aspect or the third aspect as such, wherein the first decoding indicator comprises a confidence indicator indicating a confidence level of the RP in decoding the data packet, and wherein a number of repeat packets transmitted is in accordance with the confidence level.

According to a fourth embodiment of the TP according to any preceding embodiment of the third aspect or the third aspect as such, wherein the number of repeat packets transmitted is in accordance with a confidence value derived from feedback received by the TP.

According to a fifth embodiment of the TP according to any preceding embodiment of the third aspect or the third aspect as such, wherein the programming includes instructions to configure the TP to receive a second decoding indicator indicating that the data packet was successfully decoded, and stop a remaining incomplete transmission of the repeat packets.

In a fourth aspect, the present application provides a TP adapted to perform communications. The TP includes a processor, and a computer readable storage medium storing programming for execution by the processor. The programming including instructions to perform a method of any one of the first aspect.

In a fifth aspect, the present application provides a RP adapted to perform communications. The RP includes a processor, and a computer readable storage medium storing programming for execution by the processor. The programming including instructions to configure the RP to receive a data packet from a TP, transmit a first decoding indicator indicating that the data packet was unsuccessfully decoded, and receive at least two repeat packets from the RP.

According to a first embodiment of the RP according to the fifth aspect, wherein the programming includes instructions to configure the RP to receive at least one blind repeat packet prior to transmitting the first decoding indicator.

According to a second embodiment of the RP according to any preceding embodiment of the fifth aspect or the fifth aspect as such, wherein the programming includes instructions to configure the RP to transmit feedback regarding a link between the RP and the TP.

In a fourth aspect, the present application provides a RP adapted to perform communications. The RP includes a processor, and a computer readable storage medium storing programming for execution by the processor, the programming including instructions to perform a method of any one of the second aspect.

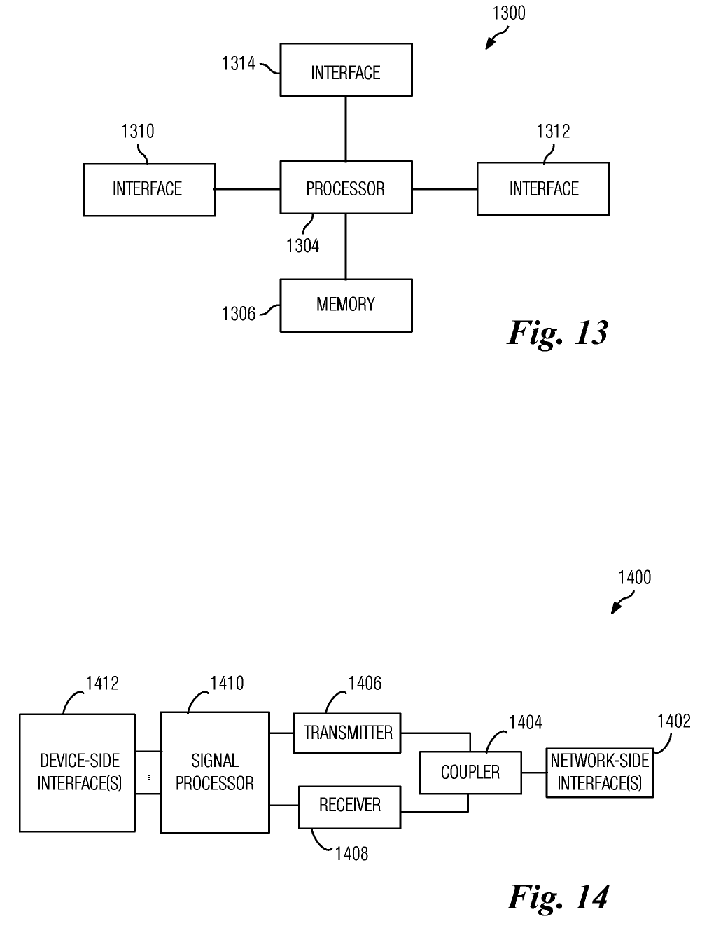

FIG. 13 illustrates a block diagram of an embodiment processing system 1300 for performing methods described herein, which may be installed in a host device. As shown, the processing system 1300 includes a processor 1304, a memory 1306, and interfaces 1310-1314, which may (or may not) be arranged as shown in FIG. 13. The processor 1304 may be any component or collection of components adapted to perform computations and/or other processing related tasks, and the memory 1306 may be any component or collection of components adapted to store programming and/or instructions for execution by the processor 1304. In an embodiment, the memory 1306 includes a non-transitory computer readable medium. The interfaces 1310, 1312, 1314 may be any component or collection of components that allow the processing system 1300 to communicate with other devices/components and/or a user. For example, one or more of the interfaces 1310, 1312, 1314 may be adapted to communicate data, control, or management messages from the processor 1304 to applications installed on the host device and/or a remote device. As another example, one or more of the interfaces 1310, 1312, 1314 may be adapted to allow a user or user device (e.g., personal computer (PC), etc.) to interact/communicate with the processing system 1300. The processing system 1300 may include additional components not depicted in FIG. 13, such as long term storage (e.g., non-volatile memory, etc.).

In some embodiments, the processing system 1300 is included in a network device that is accessing, or part otherwise of, a telecommunications network. In one example, the processing system 1300 is in a network-side device in a wireless or wireline telecommunications network, such as a base station, a relay station, a scheduler, a controller, a gateway, a router, an applications server, or any other device in the telecommunications network. In other embodiments, the processing system 1300 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 1310, 1312, 1314 connects the processing system 1300 to a transceiver adapted to transmit and receive signaling over the telecommunications network. FIG. 14 illustrates a block diagram of a transceiver 1400 adapted to transmit and receive signaling over a telecommunications network. The transceiver 1400 may be installed in a host device. As shown, the transceiver 1400 comprises a network-side interface 1402, a coupler 1404, a transmitter 1406, a receiver 1408, a signal processor 1410, and a device-side interface 1412. The network-side interface 1402 may include any component or collection of components adapted to transmit or receive signaling over a wireless or wireline telecommunications network. The coupler 1404 may include any component or collection of components adapted to facilitate bi-directional communication over the network-side interface 1402. The transmitter 1406 may include any component or collection of components (e.g., up-converter, power amplifier, etc.) adapted to convert a baseband signal into a modulated carrier signal suitable for transmission over the network-side interface 1402. The receiver 1408 may include any component or collection of components (e.g., down-converter, low noise amplifier, etc.) adapted to convert a carrier signal received over the network-side interface 1402 into a baseband signal. The signal processor 1410 may include any component or collection of components adapted to convert a baseband signal into a data signal suitable for communication over the device-side interface(s) 1412, or vice-versa. The device-side interface(s) 1412 may include any component or collection of components adapted to communicate data-signals between the signal processor 1110 and components within the host device (e.g., the processing system 1000, local area network (LAN) ports, etc.).

The transceiver 1400 may transmit and receive signaling over any type of communications medium. In some embodiments, the transceiver 1400 transmits and receives signaling over a wireless medium. For example, the transceiver 1400 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 1102 comprises one or more antenna/radiating elements. For example, the network-side interface 1102 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 1400 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a decoding unit/module, and/or a stopping unit/module. The respective units/modules may be hardware, software, or a combination thereof. For instance, one or more of the units/modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the spirit and scope of the disclosure as defined by the appended claims.

What is claimed is:

1. A method for communications, the method comprising:
transmitting, by a transmission point (TP) to a reception point (RP), a data packet;
receiving, by the TP from the RP, a first feedback indicating that the data packet was unsuccessfully decoded, wherein the first feedback comprises a confidence indicator indicating a confidence level of the RP in decoding the data packet; and
transmitting, by the TP to the RP, a plurality of retransmissions of the data packet.

2. The method of claim 1, wherein a number of retransmissions in the plurality of retransmissions of the data packet is determined in accordance with the first feedback.

3. The method of claim 1, wherein a number of retransmissions in the plurality of retransmissions of the data packet is also determined in accordance with historical information.

4. The method of claim 3, wherein historical information comprises at least one of historical transmission/reception failures or successes of the TP, or historical transmission/reception failures or successes of other devices.

5. The method of claim 1, wherein the confidence indicator is determined based on at least one of a channel quality feedback information or a decoder status information.

6. The method of claim 5, wherein the channel quality feedback information comprises information associated with at least one of a signal to noise ratio (SNR), a signal plus interference to noise ratio (SINR), a reference signal received power (RSRP), or a reference signal received quality (RSRQ), of a link between the TP and the RP, and wherein the decoder status information comprises information associated with a log likelihood ratio (LLR).

7. The method of claim 1, further comprising transmitting, by the TP before receiving the first feedback, at least one blind retransmission of the data packet.

8. The method of claim 7, wherein the data packet and the at least one blind retransmission of the data packet contain the same data.

9. A method for communications, the method comprising:
receiving, by a reception point (RP) from a transmission point (TP), a data packet;
transmitting, by the RP to the TP, a feedback indicating that the data packet was unsuccessfully decoded, wherein the feedback comprises a confidence indicator indicating a confidence level of the RP in decoding the data packet; and
receiving, by the RP from the TP, a plurality of retransmissions of the data packet.

10. The method of claim 9, wherein a number of retransmissions in the plurality of retransmissions of the data packet is determined in accordance with the feedback.

11. The method of claim 9, further comprising receiving, by the RP, at least one blind retransmission of the data packet prior to transmitting the feedback.

12. The method of claim 11, wherein the data packet and the at least one blind retransmission of the data packet contain same data.

13. The method of claim 9, wherein the confidence indicator is determined based on at least one of a channel quality feedback information comprising information associated with at least one of a signal to noise ratio (SNR), a signal plus interference to noise ratio (SINR), a reference signal received power (RSRP), or a reference signal received quality (RSRQ), of a link between the TP and the RP, or a decoder status information comprising information associated with a log likelihood ratio (LLR).

14. A transmission point (TP) adapted to perform communications, the TP comprising:
a processor; and
a computer readable storage medium storing programming for execution by the processor, the programming including instructions to configure the TP to:
transmit a data packet to a reception point (RP),
receive a first feedback from the RP, the first feedback indicating that the data packet was unsuccessfully decoded, wherein the first feedback comprises a confidence indicator indicating a confidence level of the RP in decoding the data packet, and
transmit a plurality of retransmissions of the data packet to the RP.

15. The TP of claim 14, wherein a number of retransmissions in the plurality of retransmissions of the data packet is determined in accordance with the first feedback.

16. The TP of claim 14, wherein the programming includes instructions to configure the TP to determine a number of retransmissions in the plurality of retransmissions of the data packet in accordance with historical information.

17. The TP of claim 14, wherein the confidence indicator is determined based on at least one of a channel quality feedback information or decoder status information.

18. The TP of claim 17, wherein the channel quality feedback information comprises information associated with at least one of a signal to noise ratio (SNR), a signal plus interference to noise ratio (SINR), a reference signal received power (RSRP), or a reference signal received quality (RSRQ), of a link between the TP and the RP, and wherein the decoder status information comprises information associated with a log likelihood ratio (LLR).

19. A reception point (RP) adapted to perform communications, the RP comprising:
a processor; and
a computer readable storage medium storing programming for execution by the processor, the programming including instructions to configure the RP to:
receive a data packet from a transmission point (TP),
transmit a feedback to the TP, the feedback indicating that the data packet was unsuccessfully decoded, wherein the feedback comprises a confidence indicator indicating a confidence level of the RP in decoding the data packet, and
receive a plurality of retransmissions of the data packet from the TP.

20. The RP of claim 19, wherein the programming includes instructions to configure the RP to receive at least one blind retransmission of the data packet prior to transmitting the feedback.

21. The RP of claim 19, wherein a number of retransmissions in the plurality of retransmissions of the data packet is determined in accordance with the feedback.

22. The RP of claim 19, wherein the confidence indicator is determined based on at least one of a channel quality feedback information comprising information associated with at least one of a signal to noise ratio (SNR), a signal plus interference to noise ratio (SINR), a reference signal received power (RSRP), or a reference signal received quality (RSRQ), of a link between the TP and the RP, or a decoder status information comprising information associated with a log likelihood ratio (LLR).
